(19) United States
(12) Patent Application Publication
(10) Pub. No.: US 2024/0157612 A1
(43) Pub. Date: May 16, 2024

(54) PROCESS FOR FORMING AND RELATED STATION FOR FORMING

(71) Applicant: PERSICO S.P.A., NEMBRO (IT)

(72) Inventors: Andrea FUMAGALLI, NEMBRO (IT); Sergio Battista GASTALDI, NEMBRO (IT); Matteo RADI, NEMBRO (IT)

(21) Appl. No.: 18/549,405

(22) PCT Filed: Jan. 31, 2022
(86) PCT No.: PCT/IT2022/050014

§ 371 Date: Sep. 7, 2023

(30) Foreign Application Priority Data
Mar. 9, 2021 (IT) 102021000005450

(51) Int. Cl. B29C 43/52; B29C 43/50

(52) U.S. Cl. CPC B29C 43/52; B29C 43/50; B29C 2043/5046; B29C 2043/5069

(57) ABSTRACT

Process and station (99) for forming a thermoplastic material, the process comprising: —making a semi-finished product (10) in the thermoplastic material, the semi-finished product (10) being air permeable; —closing a mould (90) with the semifinished product (10) interposed between the conformation surfaces (3, 4) for compressing the semifinished product (10) between the conformation surfaces (3, 4); —heating the mould (90) for heating the semi-finished product (10), subsequently—opening the mould (90); —with the semi-finished product (10) coupled to a second half-mould (2) of the mould (90), contacting a free surface of the semi-finished product (10) with a coupling surface (80) of a catching device (71); —generating an air flow (200) which passes through the coupling surface (80) in a distributed way, the air flow being directed from the semi-finished product (10) to the coupling surface (80), for constraining the semi-finished product (10) to the catching device (71); —while keeping the airflow (200), removing the semi-finished product (10) from the mould (90) by movement of the catching device (71); —interrupting the air flow (200) for releasing the semi-finished product (10) from the catching device (71) and obtaining a finished article.

### TECHNICAL FIELD OF THE INVENTION

The present invention relates to a process for forming and related station for forming a thermoplastic material for producing a finished article such as acoustic insulators, wadding, filters, padding, interior trims for cars, etc.

### STATE OF THE ART

Processes for forming are known in which a semi-finished product made of thermoplastic material is housed inside a mould having the final shape of the article to be produced.

For some types of thermoplastic material, for example characterized by a fibrous or spongy structure such as for the production of finished articles for paddings or the like, it is advantageous to pre-heat the mould (typically at temperatures above 120° C.). Once the semi-finished product has been inserted into the cavity of the mould, the mould is closed.

In some of these processes, after the closing of the mould, saturated or superheated vapour (or other heating fluid) at high pressure and high temperature is admitted into the cavity to speed up the heating and the consequent softening of the semi-finished product. The compression in the mould of the heated semi-finished product favours the forming of the semi-finished product, which assumes the shape determined by the conformation surfaces of the mould. In this process for forming with heating fluid, the hot mould reduces or avoids the condensation of the vapour in the mould.

Once the material has been formed, the saturated vapour is discharged in the outdoor environment. At this point the mould is opened and the article is extracted from the mould to allow the complete cooling of the semi-finished product.

Patent US2006278322A1 discloses a process for forming a polymeric semi-finished product.

### SUMMARY OF THE INVENTION

In the context of the processes for forming thermoplastic material with hot mould, (typically at temperatures above 120° C.), in particular where such materials have a fibrous or spongy structure (and therefore are typically air permeable), the Applicant has observed that the forming of the semi-finished product is favoured by a partial melting and/or partial softening of the elements making up the semi-finished product made of thermoplastic material (such as for example fibers or filaments or cells of the semi-finished product). These elements, following the compression of the semi-finished product in the mould, enter into mutual contact and/or interpenetration with each other, adhering to each other.

The stabilization and the consolidation of the shape of the formed semi-finished product to obtain the finished article take place during the cooling phase of the semi-finished product, in which the elements making up the semi-finished product undergo a solidification.

The Applicant has observed that an incomplete cooling can cause that some portions of the semi-finished product remain in a condition such that the elements making up these portions are still (at least partially) in the molten/softened state when the semi-finished product (or the finished article) is extracted from the mould and/or moved. In fact, when the mould is opened immediately after forming, the semi-finished product (and in particular the surface of the semi-finished product in contact with the lower half-mould) is at a relatively high temperature.

According to the Applicant, during the removing of the semi-finished product from the mould and/or subsequent movement, this molten/softened state of the elements making up the aforesaid portions can cause a plastic behaviour of these portions of semi-finished product, with consequent undesirable plastic (i.e., permanent) deformation. This can entail the loss of the shape imparted during the compression in the mould and/or the formation of surface defects (e.g., grooves, imprints, wrinkles and/or damage to the surface decorations) on the finished article.

The Applicant has therefore faced the problem of reducing or avoiding the risk of damaging the shape and/or the surface appearance of the finished article made of thermoplastic material after the forming with hot mould, while reducing the times of the process for forming (in particular the times required for the cooling of the semi-finished product).

According to the Applicant the above problem is solved by a process for forming and a station for forming a thermoplastic material according to the attached claims and/or having one or more of the following features.

According to an aspect the invention relates to a process for forming a thermoplastic material for producing a finished article.

The process comprises:
providing a mould comprising a first and a second half-mould, each one having a respective conformation surface;
making a semi-finished product in said thermoplastic material, said semi-finished product being air permeable;
closing said mould with said semifinished product interposed between said conformation surfaces for compressing said semifinished product between said conformation surfaces;
heating said first and second half-mould for heating said semi-finished product. Preferably, subsequently to said closing said mould and heating said first and second half-mould, the process comprises:
opening said mould;
with said semi-finished product coupled to said second half-mould, contacting a free surface of said semi-finished product with a coupling surface of a catching device;
generating an air flow which passes through said coupling surface in a distributed way, said air flow being directed from said semi-finished product to said coupling surface, for constraining said semi-finished product to said catching device;
while keeping said air flow, removing said semi-finished product from said mould by movement of said catching device;
interrupting said air flow for releasing said semi-finished product from said catching device and obtaining said finished article.

According to an aspect the invention relates to a station for forming a thermoplastic material for producing a finished article.

Preferably the station for forming comprises:
a mould comprising:
   a first and a second half-mould, each one having a respective conformation surface;
   a respective heating system at each of said first and second half-mould,
a catching device distinct from said mould, said catching device having a coupling surface, wherein a plurality of openings is distributed on said coupling surface;
a movement member for moving said catching device at least between a first position close to said second half-mould and a second position far from said second half-mould;
a sucking unit in fluid communication with said plurality of openings.

The expression “air permeable” means in a broad sense that the semi-finished product can be passed through by an air flow, as typically occurs in the case of fibrous, filamentary or spongy (i.e., with cells) material.

According to the Applicant, the contact between the semi-finished product and a catching device (in particular the coupling surface of the catching device) distinct from both the first and the second half-mould, and therefore advantageously at a temperature lower than that of the mould (e.g., typically at room temperature before contact), favours the cooling of the semi-finished product. Furthermore, the generation of an air flow which passes through the coupling surface in a distributed way (at the openings distributed on this surface) and which is directed from the semi-finished product to the coupling surface (i.e., the air flow passes through the semi-finished product and is directed towards the catching device) allows, in synergy with the previous feature, to rapidly, homogeneously and effectively lower the temperature of the semi-finished product at the end of the compression. The passage of air inside the semi-finished product in fact allows the removal of residual heat left inside the semi-finished product and the replacement with fresh air coming from the outer environment (typically at room temperature). This favours the cooling and consequent solidification of the elements making up the semi-finished product for stabilizing the final shape of the finished article. The Applicant also believes that the aforesaid air flow favours the drying of the semi-finished product, i.e., the removal of any residual moisture, for example in case of water vapour used as heating fluid of the semi-finished product. Furthermore, the air flow directed from the semi-finished product to the coupling surface (i.e., in suction from the semi-finished product) and distributed on the coupling surface (thanks to the presence of the aforesaid openings) allows, in synergy with the cooling, to keep the semi-finished product in thrust against the coupling surface (“vacuum effect”), thus creating the stable mechanical constrain between the semi-finished product and the catching device to allow the release of the semi-finished product from the mould (in particular from the second half-mould, typically arranged below) by movement of the catching device, and its moving away from the mould (in particular from the second half-mould), all without the need for manual intervention by an operator and/or without the use of mechanical tools which, given the plastic state of the thermoplastic material, could damage the shape and/or the surface appearance of the finished article, in particular in case of fibrous, filamentary or spongy thermoplastic material which is particularly yielding.

The process for forming according to the present invention allows a reduction of the process times, both due to the speeding up of the cooling process explained above, and because it is possible to synergistically cool the semi-finished product through the air flow (also) during the removal and the movement of the semi-finished product.

The present invention in one or more of the aforesaid aspects can have one or more of the following preferred features.

Preferably said free surface of said semi-finished product comprises an upper surface of said semi-finished product (which typically is at opposite side with respect to said second half-mould), more preferably said free surface consists only of said upper surface. In this way the semi-finished product is efficiently caught by the catching device.

Preferably said coupling surface of the catching device has a conformation substantially corresponding to a conformation of said conformation surface of the first half-mould, for example the conformation of the coupling surface corresponds to the conformation of the conformation surface of the first half-mould for at least 60% (preferably for at least 70%, more preferably at least 80%, even more preferably at least 90%) of a surface extension of said conformation surface of the first half-mould. On one hand this allows, in synergy with the air flow, the constraint between semi-finished product and catching device, and on the other hand to remove the semi-finished product from the mould keeping intact the surface conformation of the semi-finished product.

In one embodiment said coupling surface has a conformation coincident with the conformation of said conformation surface of the first half-mould. In this way it is possible to obtain high-quality surface conformations of the semi-finished product. Preferably said station comprises a command-and-control unit operatively connected to said movement member for commanding a movement of said movement member. Preferably said command-and-control unit is operatively connected also to said sucking unit for sending an actuation signal to said sucking unit for generating said air flow.

Preferably said movement member is a, more preferably anthropomorphic, robotic mechanical arm, even more preferably with at least five axes. In this way it is used a piece of machinery easily available on the market which favours an easy and efficient movement of the catching device.

Preferably said air flow has a flow rate per surface extension unit of said coupling surface greater than or equal to 1500 m³/h*m² and/or less than or equal to 3000 m³/h*m². In this way the cooling and the drying of the semi-finished product take place quickly and compatibly with the times required by an industrial process. Furthermore, the above air flow values allow to obtain a coupling between the semi-finished product and the coupling surface strong enough for avoiding the risk of inadvertent decoupling. Preferably each of said openings has a section greater than or equal to 3 mm², more preferably greater than or equal to 5 mm², and/or less than or equal to 20 mm², more preferably less than or equal to 10 mm². In this way the openings have a surface wide enough to allow the passage of a sufficient air amount, without at the same time causing deformations to the free surface of the semi-finished product, e.g., due to a sucking effect.

Preferably an average distance (from center to center) between said apertures is greater than or equal to 3 mm, more preferably greater than or equal to 4 mm, and/or less than or equal to 20 mm, more preferably less than or equal to 10 mm. In this way the generation of an air flow able to firmly constrained the semi-finished product is simplified.

Preferably said plurality of openings is distributed on a portion of the coupling surface having an extension greater than or equal to 70%, more preferably greater than or equal to 80%, even more preferably greater than or equal to 90%, of a total extension of said coupling surface. In this way the openings are distributed over a portion of the coupling surface such as to allow a homogeneous distribution of the air flow to obtain both the homogeneous cooling of the semi-finished product and a firm constrain of the semi-finished product with the coupling surface for a reliable removal of the semi-finished product from the mould.

Preferably said plurality of openings is distributed on the entire coupling surface. In this way the contact surface between semi-finished product and catching device is maximized.

Preferably said plurality of openings is homogenously, and more preferably equidistantly, distributed on said coupling surface. In this way a firm constrain is achieved.

Preferably said station comprises a discharging unit comprising:
a discharging surface having a plurality of further openings; and
a further sucking unit in fluid communication with said further openings.

Preferably said further openings are distributed on said discharging surface. In this way a firm coupling between semi-finished product and discharging surface is achieved.

Preferably said further openings have one or more of the above-described features relating to the openings of the coupling surface.

Preferably said generating said air flow starts only subsequently to said contacting said free surface of the semi-finished product with said coupling surface of the catching device. In this way it is avoided the risk that the air flow could cause a displacement of the semi-finished product in the second half-mould and a consequent inadequate constraint with the coupling surface (this risk would in fact be present if the air flow was generated before the contact between semi-finished product and catching device).

Preferably said contacting comprises moving said catching device to a first position close to said second half-mould.

Preferably it is provided moving said catching device from said first position to a second position far from said second half-mould, and preferably close to said discharging surface.

Preferably, before said interrupting said air flow, it is provided lying said semi-finished product on said discharging surface.

Preferably, while keeping said air flow, it is provided moving said semi-finished product from a respective first position in which said semi-finished product is coupled to (e.g., lies on) said second half-mould, at a respective second position in which said semi-finished product lies on said discharging surface (i.e., in position far from said mould) Preferably it is provided (more preferably only subsequently to lying said semi-finished product on said discharging surface) generating a further air flow which passes through said discharging surface in a distributed way, said further air flow being directed from said semi-finished product to said discharging surface (in other words, the further air flow passes through said semi-finished product in opposite direction with respect to said air flow). In this way, according to the Applicant, the release of the semi-finished product from the catching device is favoured, without any manual intervention by an operator and/or without any use of mechanical tools, since it is generated a force on the semi-finished product (through the further air flow) directed away from the catching device. In this way, the risk of damaging the finished article is limited.

Preferably said generating said further air flow starts at the same time of or subsequently to said interrupting said air flow. In this way possible damages to the semi-finished product due to the simultaneous presence of two forces (the air flow and the further air flow) acting in opposite direction on the semi-finished product are avoided.

Preferably said further air flow has a flow rate per surface extension unit of said discharging surface greater than or equal to 1500 m³/h*m² and/or less than or equal to 3000 m³/h*m². According to the Applicant this range of values of the flow rate of the further air flow allows to simply release the semi-finished product from the catching device.

Preferably it is provided, subsequently to said releasing said semi-finished product from said catching device (and preferably subsequently to said generating said further air flow), moving said catching device away from said semi-finished product (for freeing the semi-finished product).

In one embodiment it is provided, subsequently to said moving away said catching device, keeping said further air flow for a time interval (more preferably greater than or equal to 5 s and/or less than or equal to 30 s) for obtaining said finished article. In this way the further air flow completes the cooling of the semi-finished product.

In one alternative embodiment, the finished article (i.e., the semi-finished product cool enough to stably maintain the final shape given the absence of portion subjected to plastic deformations) is already obtained at the release from the catching device.

“Closing direction” means a direction of relative movement (typically vertical) between the first and second half-moulds during the opening and closing of the mould.

Preferably, with said mould closed, it is provided admitting a heating fluid between said conformation surfaces, said semi-finished product being permeable to said heating fluid. In this way it is possible to accelerate the heating of the semi-finished product and the consequent partial fusion and/or softening of the semi-finished product.

Preferably said mould comprises at least one inlet duct for a heating fluid, wherein one end of said inlet duct (directly) faces said conformation surface of said first or second half-mould.

Preferably said admitting said heating fluid is carried out by said at least one inlet duct. Preferably said heating fluid is admitted at a temperature greater than or equal to 100° C., more preferably greater than or equal to 120° C., and/or less than or equal to 250° C., more preferably less than or equal to 200° C. In this way it is possible to quickly and/or uniformly soften or partially melt the semi-finished product for obtaining, together with the compression of the semi-finished product, the desired internal bond of the semi-finished product.

Preferably said heating fluid is, more preferably saturated or superheated, (preferably water) vapour. The use of vapour, in particular saturated or superheated vapour, makes it possible to significantly reduce the cycle times of the process for forming compared, for example, to processes that use hot air ovens, adapting them to the timing required by the industrial processes.

Preferably it is provided evacuating said heating fluid from said mould, more preferably previously to said opening the mould. In this way it is possible to favour a partial cooling of the semi-finished product in order to speed up the subsequent cooling phase through air flow. The evacuation of saturated vapour also allows a partial drying of the semi-finished product.

Preferably said mould comprises at least one outlet duct for said heating fluid, wherein one end of said outlet duct (directly) faces said conformation surface of said first or second half-mould. Preferably said evacuating said heating fluid is carried out by means of said at least one outlet duct.

Preferably said heating said first and second half-mould is carried out before said closing said mould (and in any case before said admitting said heating fluid).

Preferably said first and second half-mould are heated at a temperature greater than or equal to 130° C., more preferably greater than or equal to 150° C., and/or less than or equal to 250° C., more preferably less than or equal to 230° C.

Preferably said thermoplastic material is selected in the group: polyester, polyurethane, polyethylene, polypropylene and polyamide, more preferably it is polyester, even more preferably it is PET (poly-ethylene-terephthalate), PBT (poly-butylene-terephthalate), PTT (poly-trimethylene terephthalate).

Preferably said semi-finished product comprises a plurality of layers distinct from each other and superimposed along said closing direction, more preferably having the same structure and/or the same thickness and/or made of the same thermoplastic material.

In this way, it is possible to give to the finished article the desired density and/or thickness.

In one embodiment said semi-finished product consists of a single (homogeneous) layer.

Preferably said semi-finished product (more preferably each layer of said semi-finished product) comprises, or consists of, fibers made of said thermoplastic material.

Preferably said semi-finished product (more preferably each layer of said semi-finished product) comprises a non-woven fabric, more preferably a vertically lapped non-woven fabric. In this way the semi-finished product has the desired mechanical properties.

Preferably said vertically lapped non-woven fabric has a “vertical” direction along a thickness, which coincides with a main orientation direction of the laps and, typically, of the fibers that make up the laps. Preferably this vertical direction is arranged parallelly to said closing direction of the mould.

Preferably, as for example in the case of vertically lapped non-woven fabric, said semi-finished product (more preferably each layer of said semi-finished product) comprises a fibres sheet having a plurality of laps oriented so that each lap develops from the conformation surface of the first half-mould to the conformation surface of the second half-mould. In this way, it is provided a structure to the semi-finished product which is particularly suitable for being subjected to compression in the mould.

### BRIEF DESCRIPTION OF THE DRAWINGS

FIG. 1 schematically shows a station for forming according to one embodiment of the present invention;

FIGS. 2a-g schematically show some steps of a process for forming carried out with the station for forming of FIG. 1 according to one embodiment of the present invention.

### DETAILED DESCRIPTION OF SOME EMBODIMENTS OF THE PRESENT INVENTION

The features and the advantages of the present invention will be further clarified by the following detailed description of some embodiments presented by way of non-limiting example of the present invention, with reference to the attached figures.

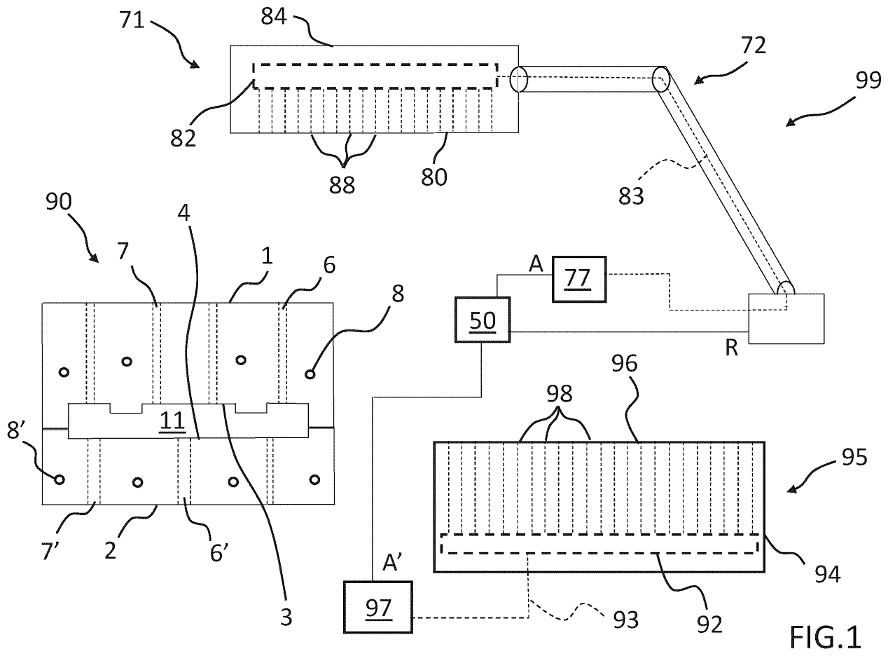

In FIG. 1, number 99 exemplarily indicates a station for forming a thermoplastic material which can be used for example for the forming of finished articles such as interior trims for cars, paddings for seats, backrests, armrests, headrests, sound-absorbing panels, wadding, etc., or parts thereof.

The station 99 comprises a mould 90. Exemplarily the station 99 also comprises a frame and further systems and devices functional to the forming, such as for example an opening/closing system of the mould 90 and feeding systems for a heating fluid and a heating medium, which are not shown as for example they can be of known type.

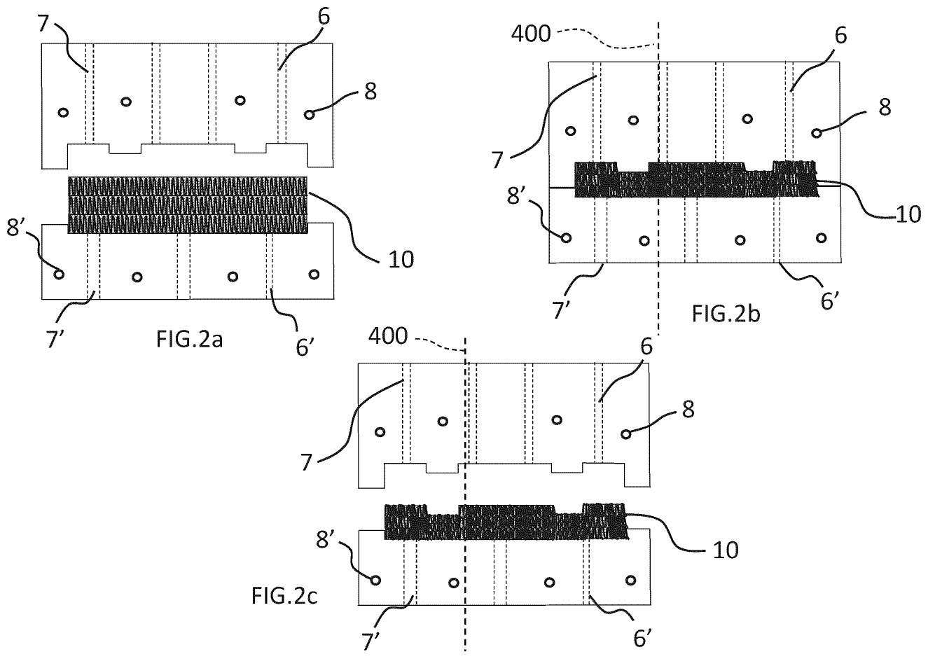

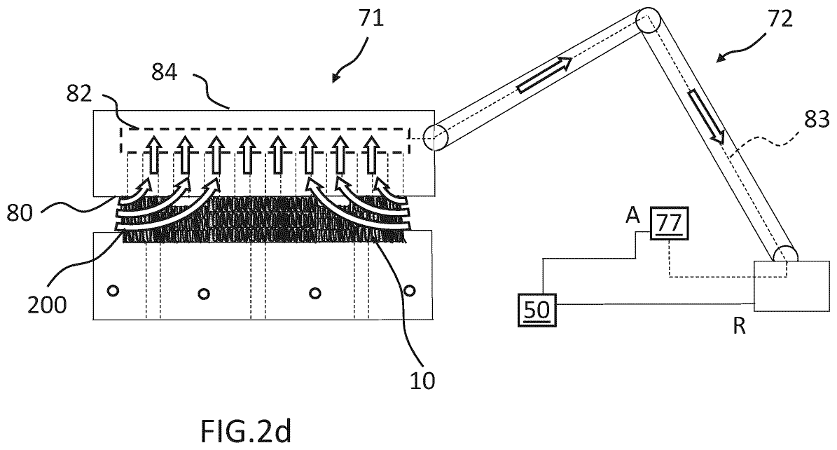

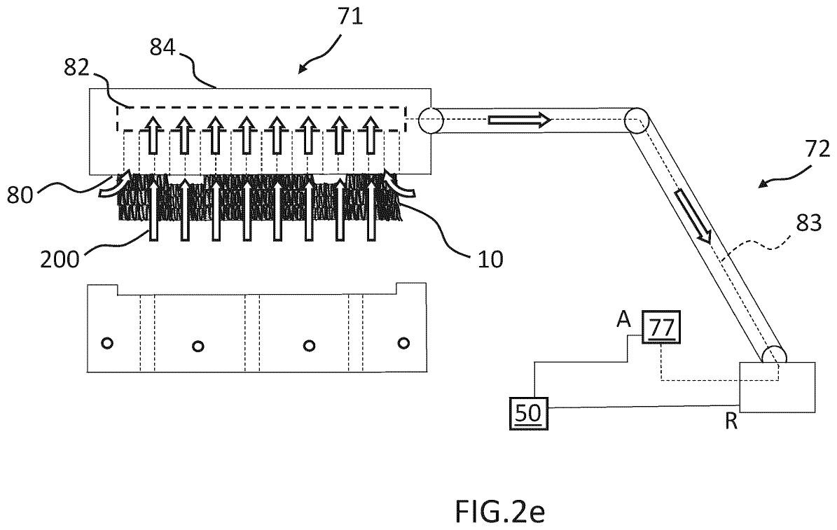

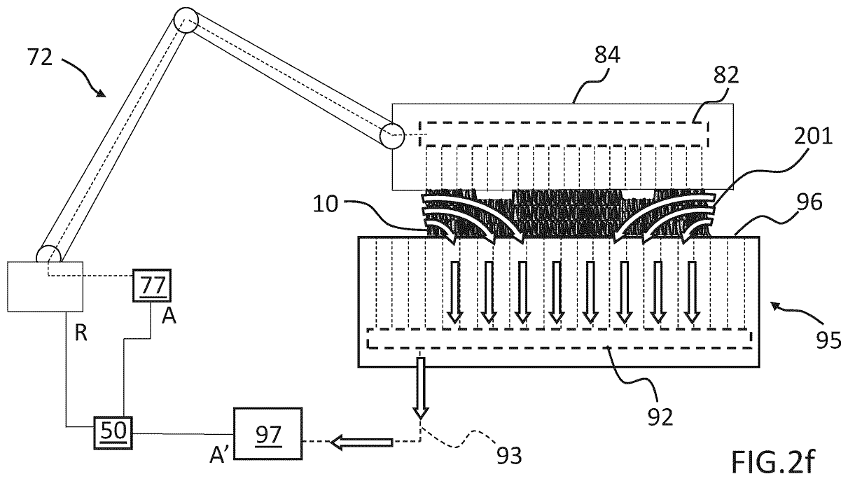

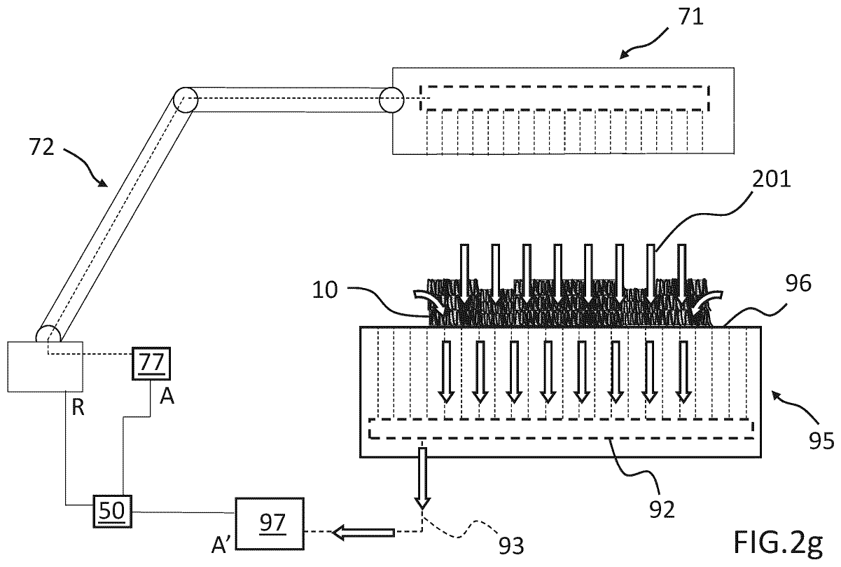

The mould 90 comprises a first 1 and a second half-mould 2 each one having a respective conformation surface 3, 4. The conformation surfaces 3, 4 define, with closed mould, a closed cavity 11 as shown in FIGS. 2a-c, or alternatively an open space interposed between the surfaces (not shown).

Exemplarily each half-mould 1 and 2 comprises at least one respective inlet duct 6 and 6′, and exemplarily also at least one respective outlet duct 7, 7′, for a heating fluid, wherein one end of each inlet duct 6 and 6′ and outlet duct 7, 7′ faces directly the conformation surface of the respective half-mould. In this way, it is possible to admit and to evacuate the heating fluid from both ends of the mould, obtaining a uniform and rapid filling/emptying of the space interposed between the conformation surfaces.

The mould 90 comprises a heating system of the first 1 and of the second half-mould 2 exemplarily comprising a plurality of respective passage ducts 8, 8′ for a heating medium at each half-mould.

Exemplarily the passage ducts 8, 8′ cross the entire body of the respective half-mould (e.g., in the direction perpendicular to the plane of the figures).

Exemplarily the passage ducts 8, 8′ are channels for allowing the flow of diathermic oil. Alternatively, the heating mean can be electricity and the passage ducts are electric resistances.

The station 99 also comprises a catching device 71 having a coupling surface 80 on which a plurality of openings 88 is distributed. Exemplarily the catching device 71 comprises a main body 84 which defines the coupling surface 80 and, inside the main body 84, a sucking chamber 82 in fluid communication with the openings 88 (as shown schematically by dashed lines in the figures).

Exemplarily the coupling surface 80 has a conformation (i.e., a 3D shape) corresponding to the conformation of the conformation surface 3 of the first half-mould 1 for about 80% of the surface extension of the conformation surface 3 (in the purely illustrative example, the two surfaces are the same except for the two reliefs on the conformation surface 3).

Exemplarily each of the openings 88 (for example of circular shape) has a section equal to about 7 mm².

Exemplarily the openings are exemplarily homogenously and equidistantly distributed on a portion of the coupling surface 80 having an extension exemplarily equal to about 90% of the total extension of the coupling surface 80.

The station 99 comprises a movement member 72 for moving the catching device 71 (at least) between a first position close to the second half-mould 2 and a second position far from the second half-mould 2.

The station 99 also comprises a sucking unit 77 connected to the sucking chamber 82 through a duct 83 (schematically shown by a dotted line) which, exemplarily, develops along the movement member 72.

Exemplarily the movement member 72 is an anthropomorphic robotic mechanical arm with six rotation axes (only schematically shown).

The present invention contemplates any number of elements in series of the movement member and any combination of translational and rotational degrees of freedom of these elements in series.

Exemplarily the station 99 comprises a discharging unit 95 comprising a discharging surface 96 having a plurality of further openings 98 distributed on it. Exemplarily the further openings also have a circular shape and a section exemplarily equal to 7 mm².

Exemplarily the further openings 98 are, exemplarily homogenously and equidistantly, distributed on the entire discharging surface 96.

Exemplarily the discharging unit 95 comprises a discharging body 94 which defines the discharging surface 96, and, inside the discharging body 94, a respective sucking chamber 92 in fluid communication with the further openings 98 (as shown schematically from the dashed lines in the figures). The discharging unit 95 also comprises a further sucking unit 97 connected to the chamber 92 through a respective duct 93 (shown schematically in dashed line).

Exemplarily the station 99 comprises a command-and-control unit 50 operatively connected (by means of the communication line R with or without wires) to the movement member 72 to send a command signal.

Exemplarily the command-and-control unit 50 is operatively connected (by means of a respective communication line A, A′ with or without wires) also to the sucking unit 77 and, for example also to the further sucking unit 97, to send a respective actuation signal to the sucking unit 77 and to the further sucking unit 97 to generate a respective air flow.

The present invention contemplates any arrangement and logical and/or physical division of the command-and-control unit, which can for example be a single physical and/or logical unit (as exemplarily shown in FIG. 1) or composed of several physical and/or logical units distinct and cooperating with each other, such units being able to be located, in whole or in part, respectively in the movement member, in the sucking unit and in the further sucking unit.

With reference to FIGS. 2a-g, an example of a process for forming a thermoplastic material to produce a finished article according to the present invention is shown, through the use of the station for forming 99.

The process for forming comprises making a semi-finished product 10 made of the thermoplastic material, for example PET.

Exemplarily the semi-finished product 10 comprises a plurality of layers (for example three layers) distinct from each other and superimposed along the closing direction 400 of the mould 90. Exemplarily the layers are equal to each other (have the same structure, the same thickness and are made of the same thermoplastic material). In addition, the layers all have a constant thickness and density, so that the semi-finished product initially has a constant thickness and a constant density throughout the entire extension of the conformation surfaces.

Exemplarily each layer of the semi-finished product 10 comprises a vertically lapped non-woven fabric, for example made by using the machinery marketed by V-Lap Pty Ltd (see for example US2008155787A1) or by Struto International, Inc. or the process described in U.S. Pat. No. 8,357,256B2. Examples of vertically lapped non-woven fabrics are described in US2019/0248103A1.

In one alternative example, each layer of the semi-finished product 10 can comprise a horizontally lapped non-woven fabric.

Exemplarily each layer of the semi-finished product 10 comprises a continuous sheet of fibers (initially typically loosely bound together) which is repeatedly folded on itself to form a plurality of laps with an overall pattern of ridges and valleys. In this way the vertically lapped non-woven fabric has a vertical direction along the thickness which coincides with the main orientation direction of the laps and, for example, also of the fibers of the sheet.

The semi-finished product 10 is placed in the open mould 90, i.e., with the two half-moulds mutually spaced apart (FIG. 2a), with the vertical direction (i.e., the direction of the thickness of the vertically lapped non-woven fabric) arranged parallelly to the closing direction 400. In this way the laps (and typically also the fibers) are oriented so as to develop from the conformation surface 3 of the first half-mould 1 to the conformation surface 4 of the second half-mould 2.

Initially it is provided heating the first 1 and the second half-mould 2 through the heating medium, exemplarily diathermic oil, exemplarily at a temperature equal to about 170° C. At this point the mould 99 is closed, i.e., the two half-moulds 1, 2 are mutually approached, with the semi-finished product 10 interposed between the conformation surfaces 3, 4 (FIG. 2b), to compress the semi-finished product between the conformation surfaces.

With closed mould, (through the inlet ducts 6 and 6′) the heating fluid, for example saturated vapour, is admitted between the conformation surfaces 3, 4 (i.e., in the cavity 11 in the example shown) to heat the semi-finished product 10 which is permeable to the heating fluid. Alternatively, the heating fluid can be superheated air.

Exemplarily the saturated vapour is admitted at a temperature equal to about 160° C. (advantageously the first 1 and the second half-mould 2 are heated to a temperature higher than the admission temperature of the heating fluid).

Exemplarily the saturated vapour is admitted at a pressure equal to about 6 bar (typically the forming pressure is between 1 and 20 bar).

Exemplarily the saturated vapour is kept between the conformation surfaces 3, 4 for a time interval equal to about 10 s (typically this time interval is less than 60 s).

Subsequently the saturated steam is evacuated from the mould 90, exemplarily through the outlet ducts 7, 7′ which connect each conformation surface 3, 4 with the outdoor environment of the mould 90, to favour a partial cooling of the semi-finished product 10 and to depressurize the cavity 11.

At this point the mould 90 is opened, i.e., the two half-moulds are again moved away from each other, (FIG. 2c) to allow the completion of the cooling and the removal of the semi-finished product 10 from the mould.

By commanding the movement member 72, the catching device 71 is moved to a first position close to the second half-mould 2 (shown in FIG. 2d), and the coupling surface 80 of the catching device 71 is brought in contact with a free surface of the semi-finished product 10, exemplarily consisting in only the upper surface of the semi-finished product 10, with the semi-finished product 10 still lying on the (hot) second half-mould 2.

At this point, exemplarily subsequently to the contact, an air flow 200 (schematically indicated by the arrows in FIG. 2d) directed from the semi-finished product 10 to the coupling surface 80 is generated (by means of the sucking unit 77 in fluid communication with the openings 88) to constrain the semi-finished product 10 to the coupling surface 80. As long as the semi-finished product 10 is in contact with the conformation surface 4 of the second half-mould 2, exemplarily the air flow 200 starts from the outer environment, passes through the lateral surface of the semi-finished product 10 (air permeable), (at least in part) the semi-finished product 10 itself, the openings 88, and reaches the sucking chamber 82 (and from here the sucking unit 77 through the duct 83).

Subsequently, while keeping the air flow 200 in suction (FIG. 2e), the semi-finished product 10 is removed from the mould 90 by movement of the catching device 71. In this situation, the air flow 200 typically also passes through the lower surface of the semi-finished product 10, previously in contact with the second half-mould (i.e., the lower half-mould) and involves the entire semi-finished product 10.

The catching device 71 with the semi-finished product 10 constrained to the coupling surface 80 is then moved away from the second half-mould and laid on the discharging surface 96 (FIG. 2f).

Exemplarily after the lying of the semi-finished product 10 on the discharging surface 96, the air flow 200 directed from the semi-finished product 10 to the coupling surface 80 is interrupted. Exemplarily simultaneously (or subsequently) to this interruption of the air flow 200, a further air flow 201 (schematically indicated by the arrows in FIG. 2f) directed from the semi-finished product 10 to the discharging surface 96 is generated (by activating the further sucking unit 97).

The interruption of the air flow 200 and the generation of the further air flow 201 allow the semi-finished product 10 to be released from the catching device 71, which is subsequently moved away from the discharging surface 96 (FIG. 2g).

Exemplarily the further air flow 201 is kept active for a time interval equal to about 30 s after the catching device 71 has been moved away from the discharging surface 96, to complete the cooling of the semi-finished product 10 to obtain the finished article. By then interrupting also the further air flow 201 it is possible to remove the finished article from the discharging surface 96.

1. A process for forming a thermoplastic material for producing a finished article, the process comprising:
providing a mould comprising a first and a second half-mould, each one having a respective conformation surface;
making a semi-finished product in said thermoplastic material, said semi-finished product being air permeable;
closing said mould with said semifinished product interposed between said conformation surfaces for compressing said semifinished product between said conformation surfaces;
heating said first and second half-mould for heating said semi-finished product,
wherein, subsequently to said closing said mould and heating said first and second half-mould, the process comprises:
opening said mould;
with said semi-finished product coupled to said second half-mould, contacting a free surface of said semi-finished product with a coupling surface of a catching device;
generating an air flow which passes through said coupling surface in a distributed way, said air flow being directed from said semi-finished product to said coupling surface, for constraining said semi-finished product to said catching device;
while keeping said air flow, removing said semi-finished product from said mould by movement of said catching device;
interrupting said air flow for releasing said semi-finished product from said catching device and obtaining said finished article.

2. The process according to claim 1, wherein said free surface of said semi-finished product comprises an upper surface of said semi-finished product, and wherein said coupling surface of the catching device has a conformation corresponding to a conformation of said conformation surface of the first half-mould for at least 60% of a surface extension of said conformation surface of the first half-mould.

3. The process according to claim 1, wherein said air flow has a flow rate per surface extension unit of said coupling surface greater than or equal to 1500 m³/h*m² and/or less than or equal to 3000 m³/h*m², wherein said generating said air flow starts only subsequently to said contacting said free surface of the semi-finished product with said coupling surface of the catching device, wherein said contacting comprises moving said catching device to a first position close to said second half-mould, and wherein said process comprises moving said catching device from said first position to a second position far from said second half-mould and close to a discharging surface.

4. The process according to claim 1, comprising:
while keeping said air flow, moving said semi-finished product from a respective first position in which said semi-finished product is coupled to said second half-mould at a respective second position in which said semi-finished product lies on a discharging surface;
generating a further air flow which passes through said discharging surface in a distributed way, said further air flow being directed from said semi-finished product to said discharging surface, wherein said generating said further air flow starts at the same time of or subsequently to said interrupting said air flow, and wherein said further air flow has a flow rate per surface extension unit of said discharging surface greater than or equal to 1500 m³/h*m² and/or less than or equal to 3000 m³/h*m².

5. The process according to claim 4, comprising:
subsequently to said releasing said semi-finished product from said catching device and subsequently to said generating said further air flow, moving said catching device away from said semi-finished product; and
subsequently to said moving away said catching device, keeping said further air flow for a time interval greater than or equal to 5 s and/or less than or equal to 30 s for obtaining said finished article.

6. The process according to claim 1, comprising:
with said mould closed, admitting a heating fluid between said conformation surfaces, said semi-finished product being permeable to said heating fluid;
evacuating said heating fluid from said mould previously to said opening the mould,
wherein said heating fluid is saturated steam, wherein said heating fluid is admitted at a temperature greater than or equal to 100° C. and/or less than or equal to 250° C., and wherein said heating said first and second half-mould is carried out before said closing said mould and at a temperature greater than or equal to 130° C. and/or less than or equal to 250° C.

7. The process according to claim 1, wherein said thermoplastic material is selected in the group: polyester, polyurethane, polyethylene, polypropylene and polyamide, wherein said semi-finished product comprises a vertically lapped non-woven fabric, and wherein said semi-finished product comprises a fibres sheet having a plurality of laps oriented so that each lap develops from the conformation surface of the first half-mould to the conformation surface of the second half-mould.

8. A station for forming a thermoplastic material for producing a finished article, the station for forming comprising:
a mould comprising:
a first and a second half-mould, each one having a respective conformation surface;
a respective heating system at each of said first and second half-mould,
a catching device distinct from said mould, said catching device having a coupling surface, wherein a plurality of openings is distributed on said coupling surface;
a movement member for moving said catching device at least between a first position close to said second half-mould and a second position far from said second half-mould;
a sucking unit in fluid communication with said plurality of openings.

9. The station according to claim 8, comprising a command-and-control unit operatively connected to said movement member for commanding a movement of said movement member, and to said sucking unit for sending an actuation signal to said sucking unit for generating an air flow, and wherein said movement member is an anthropomorphic robotic mechanical arm with at least five axes.

10. The station according to claim 8, comprising a discharging unit comprising:
a discharging surface having a plurality of further openings distributed on said discharging surface; and
a further sucking unit in fluid communication with said further opening,
wherein each of said openings and said further openings has a section greater than or equal to 3 mm² and/or less than or equal to 20 mm², wherein an average distance between said apertures and an average distance between said further openings is greater than or equal to 3 mm and/or less than or equal to 20 mm, wherein said plurality of openings and said plurality of further openings are distributed on a portion respectively of the coupling surface and of the discharging surface having an extension greater than or equal to 70%, preferably greater than or equal to 90%, of a total extension of respectively said coupling surface and said discharging surface, and wherein said plurality of openings and said plurality of further openings are homogenously and equidistantly distributed respectively on said coupling surface and said discharging surface.
